(19) United States
(12) Patent Application Publication
(10) Pub. No.: US 2026/0001342 A1
(43) Pub. Date: Jan. 1, 2026

(54) CONTAINER FOR LIQUID CARTRIDGE, LIQUID CARTRIDGE CONTAINER, AND METHOD FOR COLLECTING LIQUID CARTRIDGE

(71) Applicant: CANON KABUSHIKI KAISHA, Tokyo (JP)

(72) Inventors: SOJI KONDO, Kanagawa (JP); TATSUO NANJO, Kanagawa (JP); KEISUKE IINUMA, Kanagawa (JP); HIROSHI KOSHIKAWA, Kanagawa (JP); HIROSHI YAMADA, Kanagawa (JP)

(21) Appl. No.: 19/248,234

(22) Filed: Jun. 24, 2025

(30) Foreign Application Priority Data
Jun. 28, 2024 (JP) 2024-104681

(51) Int. Cl. B41J 2/175

(52) U.S. Cl. CPC B41J 2/17533; B41J 2/17553

(57) ABSTRACT

A container for storing a liquid cartridge that is attachable to a liquid discharge apparatus, the container includes a storage unit including a bottom and at least four side walls, and an opening facing the bottom, wherein a plurality of ribs protrudes from an inner surface of at least one of the at least four side walls of the storage unit toward an inside of the storage unit and extends from the bottom toward the opening, and wherein the plurality of ribs includes a plurality of first ribs, the plurality of first ribs is configured to protrudes in a direction parallel to the bottom and inclined relative to the side walls.

### BACKGROUND

### Field of Technology

The present disclosure relates to a container for liquid cartridge, a liquid cartridge container, and a method for collecting a liquid cartridge.

### Description of the Related Art

A typical ink jet recording apparatus is a liquid discharge apparatus that discharges a liquid, such as ink, from a liquid discharge head to perform desired recording. An ink tank for storing ink and a liquid discharge head for discharging the ink stored in the ink tank can be attached to the ink jet recording apparatus when in use. Some ink jet recording apparatuses are of a type in which a liquid cartridge, such as an ink cartridge which is a cartridge-formed ink tank, and a liquid discharge head cartridge which is a cartridge-formed liquid discharge head are separately attached. Some other ink jet recording apparatuses are of another type in which a liquid discharge head-equipped ink cartridge, in which an ink tank and a liquid discharge head are integrally formed as a cartridge, is attached.

During transportation, a liquid cartridge is applied with a seal on the ink supply ports which are connected to the liquid discharge head, and then stored in a container for the liquid cartridge. A so-called a blister pack is often used as a container for the liquid cartridge. Likewise, a liquid discharge head-equipped ink cartridge is applied with a seal on the discharge ports of the liquid discharge head, and then stored in a container for the liquid discharge head-equipped ink cartridge. Also, the so-called blister pack is often used as a container for the liquid discharge head-equipped ink cartridge. A liquid discharge head cartridge container discussed in Japanese Patent Application Laid-Open No. 2001-10082 has a main body having an opening on the surface facing the bottom surface, and including a holding unit for holding a liquid discharge head cartridge. The container for the liquid discharge head cartridge is also provided with a cover to cover the opening of the main body. On the side surfaces of the main body, ribs having an approximately columnar shape extend from the bottom surface side to the opening. The liquid discharge head cartridge container discussed in Japanese Patent Application Laid-Open No. 2001-10082 is configured to prevent deformations even with changes in external environmental conditions (ambient temperature and pressure) during transportation and protect the liquid discharge head cartridge against environmental changes.

The ribs having an approximately columnar shape disposed to the liquid discharge head cartridge container discussed in Japanese Patent Laid-Open No. 2001-10082 prevent the container from being entirely deformed due to changes of external environmental conditions (air pressure and temperature). However, if a drop shock is transmitted from the container to the liquid discharge head cartridge via the ribs, the liquid discharge head cartridge may be damaged. Particularly, there is an issue that an ink cartridge filled with a large volume of ink to increase the guaranteed number of sheets to be printed and a liquid discharge head-equipped ink cartridge are relatively heavy, and the impact received by the ink cartridge in a fall is large.

### SUMMARY

The present disclosure has been made in view of the above-described issue, and is directed to providing a liquid cartridge container that prevents damages to a liquid cartridge stored in the container even if the container is subjected to impact.

According to an aspect of the present disclosure, a container for storing a liquid cartridge that is attachable to a liquid discharge apparatus, the container includes a storage unit including a bottom and at least four side walls, and an opening facing the bottom, wherein a plurality of ribs protrudes from an inner surface of at least one of the at least four side walls of the storage unit toward an inside of the storage unit and extends from the bottom toward the opening, and wherein the plurality of ribs includes a plurality of first ribs which are configured to protrude in a direction parallel to the bottom and inclined relative to the side walls.

Further features of the present disclosure will become apparent from the following description of embodiments with reference to the attached drawings.

### BRIEF DESCRIPTION OF THE DRAWINGS

FIG. 1A is a cross-sectional view illustrating a liquid discharge head-equipped ink cartridge viewed in a side surface direction. FIGS. 1B and 1C are perspective views illustrating the ink cartridge.

FIG. 2 is a cross-sectional view illustrating a container viewed in the side surface direction.

FIG. 3A is a perspective view illustrating the container and the liquid discharge head-equipped ink cartridge. FIGS. 3B and 3C are perspective views illustrating the container.

FIGS. 4A to 4C are cross-sectional views illustrating the container for the liquid discharge head-equipped ink cartridge and the liquid discharge head-equipped ink cartridge stored in the container viewed in an upper surface direction and lower surface direction.

FIGS. 5A and 5B are cross-sectional views illustrating the container for the liquid discharge head-equipped ink cartridge, and the liquid discharge head-equipped ink cartridge stored in the container viewed in a front surface direction.

FIGS. 6A to 6D are diagrams illustrating states in which the container for the liquid discharge head-equipped ink cartridge is dropped, and a rib bends to provide an elastic effect.

FIG. 7 is a cross-sectional view illustrating the container for the liquid discharge head-equipped ink cartridge, and the liquid discharge head-equipped ink cartridge stored in the container viewed in the side surface direction.

### DESCRIPTION OF THE EMBODIMENTS

Embodiments for implementing the present disclosure will be illustratively described in detail below with reference to the drawings based on an embodiment. However, the dimensions, materials, shapes, and relative arrangements of the components described in the embodiment should be appropriately modified according to the configuration of the device to which the disclosure is applied and various conditions. That is, the scope of the present disclosure is not intended to be limited to the following embodiment.

A container according to the present embodiment is a liquid discharge head container in which a liquid discharge head is stored when the liquid discharge head is distributed on the market. The present embodiment will be described below centering on the liquid discharge head container. However, a target to be stored in the container is not limited to a liquid discharge head. Examples of the target include a liquid cartridge for replenishing a liquid to a liquid discharge head (ink jet head) included in an ink jet printer, and a liquid cartridge having a liquid discharge head. In the below description, an ink cartridge for storing ink as a liquid will be described below.

### <Liquid Discharge Head-Equipped Liquid Cartridge>

In the following descriptions, a Z direction refers to a height direction of a liquid cartridge in a state where the liquid cartridge is attached to a liquid discharge apparatus. An X direction perpendicular to the Z direction refers to a width direction of the liquid cartridge. a Y direction perpendicular to the X and Z directions refers to a depth direction of the liquid cartridge.

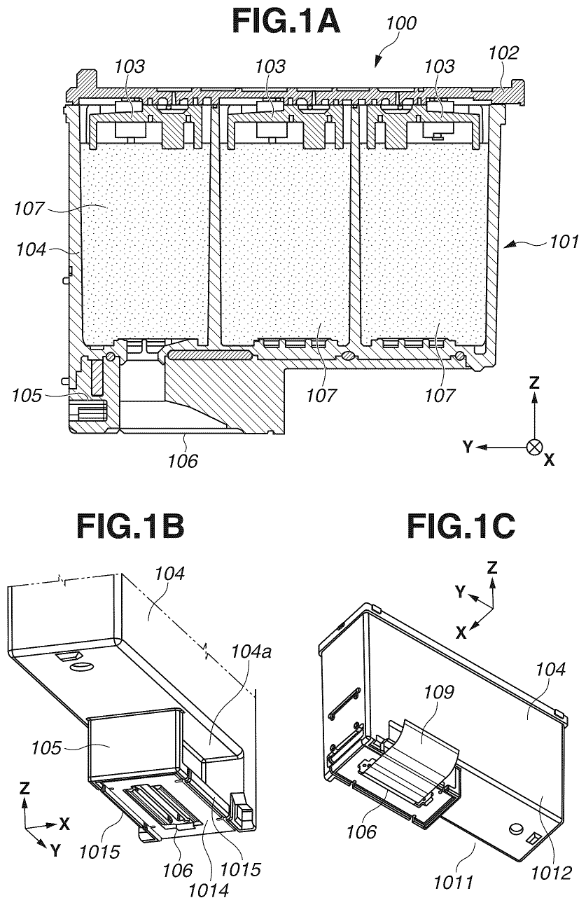

FIG. 1A is a cross-sectional view illustrating a liquid discharge head-equipped ink cartridge 100 viewed in a side surface direction. FIGS. 1B and 1C are perspective views illustrating the liquid discharge head-equipped ink cartridge 100. The liquid discharge head-equipped ink cartridge 100 (hereinafter simply referred to as an ink cartridge 100) includes a tank case 101, a tank cover 102, and rib plates 103. The tank case 101 includes one or more ink stores (e.g., reservoirs) 104, a head unit 105, and a discharge substrate 106 having discharge ports.

Each of the ink stores 104 is padded with an absorber 107 for holding ink. The tank cover 102 has an air communication port (not shown). The rib plates 103 described above are disposed between the absorbers 107 and the tank cover 102.

The head unit 105 is disposed at a position so that the head unit 105 is connected to a bottom of the ink stores 104. Since the width of the head unit 105 is smaller than the width of the ink stores 104, a bottom 104a is formed near the portion where the head unit 105 is connected to the bottom of the ink stores 104. The discharge substrate 106 is connected at the lower end of the head unit 105. A head fixing surface 1014 to which the discharge substrate 106 is disposed has head fixing part side faces 1015 at both ends. The head fixing part side faces 1015 are disposed on inner positions (positions closer to the ink stores 104 in the X direction) than a first side surface 1011 and a second side surface 1012 of the ink cartridge 100.

Even if the ink cartridge 100 turns over, the absorbers 107 hold ink. Even if ink overflows from the absorbers 107, the rib plates 103 prevent the ink from communicating with the air communication port. With this configuration, ink leakage is prevented even if the ink cartridge 100 turns over.

At the time of printing, the ink in the ink stores 104 is discharged from the discharge ports. With a decrease in the amount of the ink in the ink storages 104 by ink discharge, air is introduced from the air communication port to the ink stores 104.

Before the ink cartridge 100 is stored in a container 110 described below, a protection seal 109 is stuck across the discharge substrate 106 and a lower end of the ink stores 104, as illustrated in FIG. 1C.

### <Container for Liquid Discharge Head-Equipped Ink Cartridge>

The container 110 for storing the ink cartridge 100 (hereinafter simply referred to as the container 110) according to the present disclosure will be described in detail below.

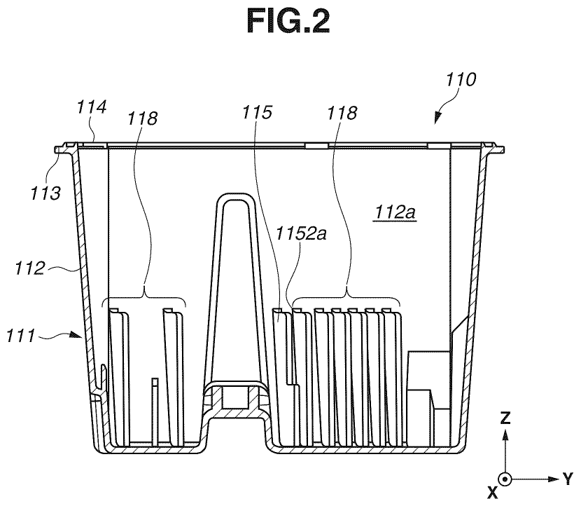

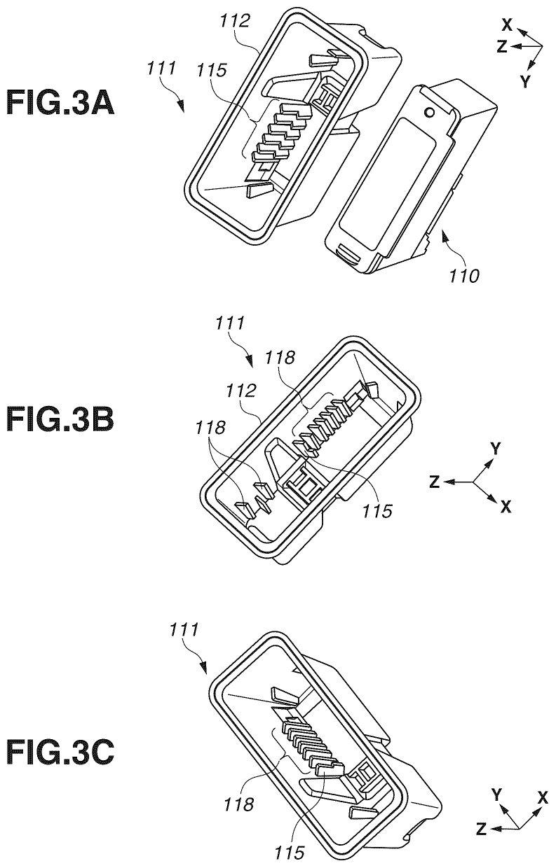

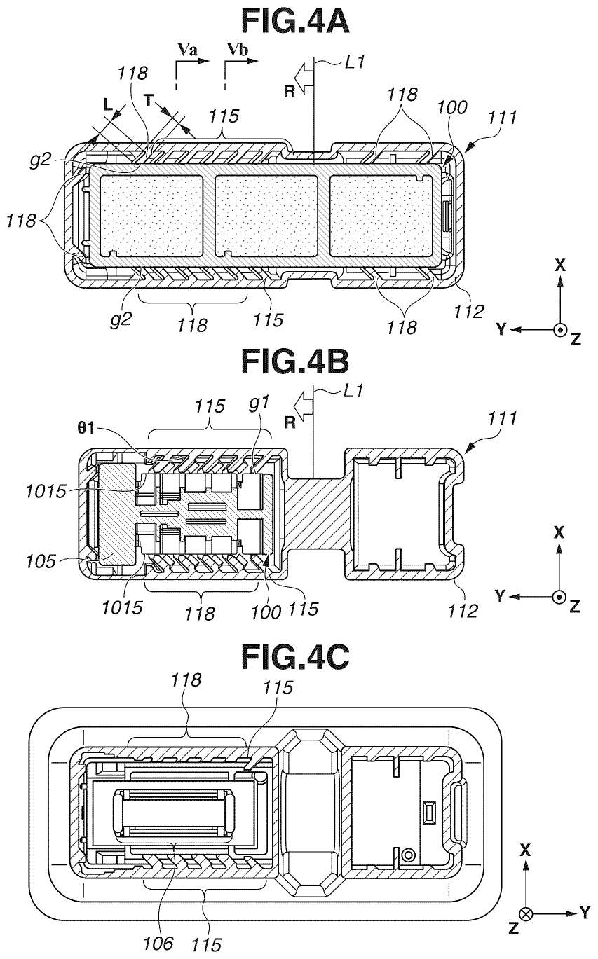

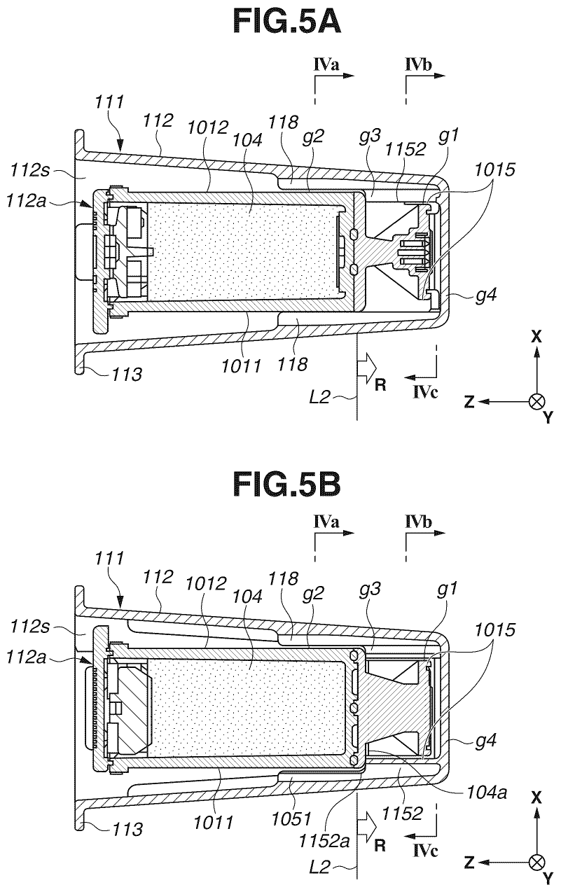

FIG. 2 is a cross-sectional view illustrating the container 110 viewed in the side surface direction. FIG. 3A is a perspective view illustrating the container 110 and the ink cartridge 100. FIG. 3B is a perspective view illustrating the container 110 viewed from an angle different from an angle of FIG. 3A. FIG. 3C is a perspective view illustrating the container 110 viewed from another angle different from the angles of FIGS. 3A and 3B. FIG. 4A is a cross-sectional view illustrating the container 110 and the ink cartridge 100 stored in the container 110 taken along an IVa-IVa line illustrated FIG. 5A described below viewed in an upper surface direction. FIG. 4B is a cross-sectional view taken along an IVb-IVb line illustrated in FIG. 5A viewed in the upper surface direction. FIG. 4C is a cross-sectional view taken along an IVc-IVc line illustrated in FIG. 5A viewed in the lower surface direction. FIG. 5A is a cross-sectional view taken along a Va-Va line illustrated in FIG. 4A viewed in a front surface direction. FIG. 5B is a cross-sectional view taken along a Vb-Vb line illustrated in FIG. 4A viewed from the front surface direction.

Referring to FIG. 2, the container 110 includes a main body 111 and a cover 114. The main body 111 includes a storage unit 112 that forms a storage space 112a to store the ink cartridge 100, and a flange 113 extending from the opening of the storage unit 112 toward the outer circumference. The ink cartridge 100 is able to be stored in the storage unit 112 through the opening of the storage unit 112 in the upper surface direction of the storage unit 112. The storage unit 112 of the main body 111 includes the bottom and at least four side walls. The container 110 with the ink cartridge 100 stored therein is a configuration of a liquid cartridge container 1000 for an ink cartridge.

When the ink cartridge 100 is stored in the storage unit 112 and then the cover 114 is bonded to the flange 113, an enclosed space is formed. According to the present embodiment, the cover 114 is a film, and the bonding part between the container 110 and the cover 114 is sealed by heat sealing. However, other bonding methods are also applicable. For example, the present embodiment uses a laminate film of a polyethylene terephthalate (PET) resin and polypropylene (PP) as the material of the cover 114, and uses polypropylene (PP) as the material of the container 110. However, the materials of the cover 114 and the container 110 are not limited thereto.

Recycled plastics may also be used as materials of the cover 114 and the main body 111.

Recycled plastic materials according to the present disclosure include post-consumer materials (PCR materials) and pre-consumer materials in a broad sense. Recycled plastic materials are made from raw materials that have experienced some degree of degradation due to the thermal history during molding, as well as stress, heat, light, solvents, and the like during use. Under such circumstances, recycled plastic materials are known to have different physical characteristics from virgin materials. For example, in terms of shock absorbing characteristics, which reduce a force upon impact by bending of molecular chains within the materials, recycled plastic materials tend to have deteriorated shock absorbing characteristics. This tendency can be tested by the Charpy impact test, and molded materials containing recycled plastic materials have a lower impact tendency than the tendency of virgin materials. The deterioration of the shock absorption characteristics is due to disconnection of the original molecular chains by the above described degradation, resulting decrease in shock reduction effects of molecular chains themselves.

The ribs included in the main body 111 will be described below with reference to FIGS. 2, 3A to 3C, 4A to 4C, 5A, and 5B. Second ribs 118 and first ribs 115 are disposed on inner side surface (inner surfaces of the side walls) of the storage unit 112 of the main body 111. In the following descriptions, the second ribs 118 and the first ribs 115 are collectively referred to as “ribs”. According to the present embodiment, the ribs are integrally molded with the main body 111. The ribs inwardly extend from the inner side surface of the storage unit 112. More specifically, the ribs protrude from the inner side surface of the storage unit 112 toward the storage space 112a. In other words, the ribs protrude in a direction parallel to the bottom of the storage unit 112 and inclined relative to the side wall of the storage unit 112.

The second ribs 118 have an approximately constant protrusion length in their protrusion direction (XY plane direction). On the other hand, each of the first ribs 115 has two different parts having different protrusion lengths in the protrusion direction (XY plane direction), one of which is a first part 1151 having an approximately the same protrusion length as the second ribs 118, and the other of which is a second part 1152 having a longer protrusion length than the first part 1151.

Both the second ribs 118 and the first ribs 115 are inclined and are disposed at positions close to the first side surface 1011 and the second side surface 1012 of the ink cartridge 100.

In a position of the ink cartridge 100 stored in the storage unit 112, there are gaps g2 of a distance G2 on the XY plane between the second ribs 118 and the side surface of the ink cartridge 100 and between the first part 1151 of each of the first ribs 115 and the side surface of the ink cartridge. The second part 1152 of each of the first ribs 115 is disposed at a position close to the head fixing part side face 1015, and there is a gap g1 of a distance G1 between the second part 1152 and the head fixing part side face 1015 on the XY plane. There is a gap g3 of a distance G3 between the second ribs 118 and the head fixing part side face 1015 (see FIGS. 5A and 5B). The distance G2 is shorter than the distances G3 and G1. In a state where the ink cartridge 100 is stored in the main body 111, the position of the ink cartridge 100 is regulated in the storage unit 112 by the second ribs 118 and the first parts 1151. More specifically, the second ribs 118 and the first parts 1151 serve as position regulation members for the ink cartridge 100.

As illustrated in FIGS. 4A to 4C, 5A, and 5B, most of the storage space 112a is occupied by the ink cartridge 100 when the ink cartridge 100 is stored in the storage unit 112, and a gap space 112s is formed between the storage unit 112 and the ink cartridge 100. The gap space 112s is the space within the storage space 112a, excluding the portion occupied by the ink cartridge 100.

Referring to the cross-sectional view illustrated in FIG. 4A viewed in the upper surface direction, the second ribs 118 and the first ribs 115 inclined relative to both the inner side surface of the storage unit 112 and the outer side surface of the ink cartridge 100. More specifically, the direction in which each of the second ribs 118 and the first ribs 115 inwardly extends includes the component inclined relative to the outer surface of the ink cartridge 100 in a state where the ink cartridge 100 is stored in the storage unit 112, over the entire range where the second ribs 118 and the first ribs 115 extend in the Z direction.

As illustrated in FIG. 4A, the ink cartridge 100 has a rectangular cross-sectional shape, and the storage unit 112 also has a rectangular cross-sectional shape, and each side of the ink cartridge 100 is parallel to each side of the storage unit 112. This also means that the direction in which each of the second ribs 118 and the first ribs 115 inwardly extends on the XY plane includes the component inclined relative to the inner surface of the storage unit 112 in a state where the ink cartridge 100 is stored in the storage unit 112, over the entire range of second ribs 118 and the first ribs 115. Alternatively, a rib may have both a portion having a component inclined relative to the inner surface of the storage unit 112 and a portion not having a component inclined relative to the inner surface of the storage unit 112.

Referring to FIGS. 4A and 5A, when the ink cartridge 100 is stored in the storage unit 112, the head unit 105 is stored in a head storage region R which is a region on the left of a line L1 illustrated in FIGS. 4A and 4B when viewed from the upper surface, and below a line L2 illustrated in FIGS. 5A and 5B when viewed from the front. Referring to the cross-sectional view in FIG. 4A, the head storage region R includes six first ribs 115 on the upper side of the ink cartridge 100, two second ribs 118 on the left side of the ink cartridge 100, and six second ribs 118 and one first rib 115 on the lower side of the ink cartridge 100. As illustrated in the cross-sectional views in FIGS. 4B and 4C, the head storage region R includes a total of six first ribs 115 on both side surfaces of the head fixing portion.

Referring to FIGS. 4A and 4B, it is desirable that the second ribs 118 and the first ribs 115 have a thickness T of 0.5 mm or more and 2.0 mm or less (the thickness T refers to a length in the direction perpendicular to the inwardly extending direction on the XY plane). Also, it is desirable that the first ribs 115 have a length L of 2.0 mm or more in the inwardly extending direction (inwardly extending direction on the XY plane). According to the present embodiment, for example, the length L is 2.8 mm. As illustrated in FIGS. 5A and 5B, the length of the first ribs 115 in the vertically extending direction (Z direction) is longer than the height of the head unit 105. With this configuration, a gap g4 is able to be provided between the storage unit 112 and the discharge substrate 106 at the lower end of the head unit 105 as described below.

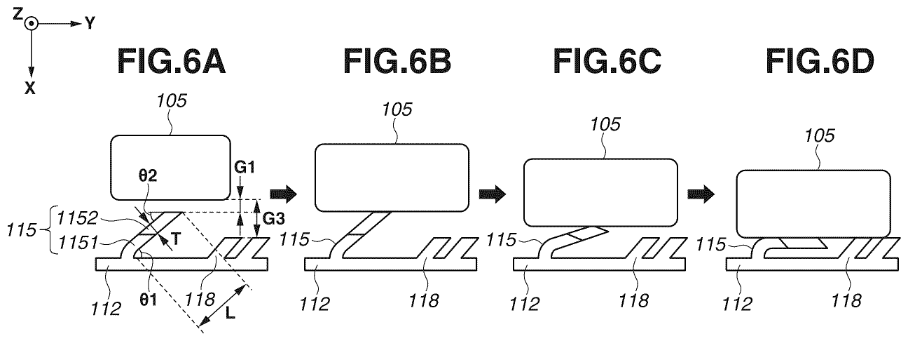

Referring to FIGS. 4A and 4B, it is desirable that an angle θ1 in the extending direction (inwardly extending direction on the XY plane) of the second ribs 118 and the first ribs 115 intersecting relative to the inner side surface of the storage unit 112 be 30 degrees or more and 45 degrees or less. More desirably, the angle θ1 is 45 degrees. Further, in a case where the outer side surface of the ink cartridge 100 is parallel to the inner side surface of the storage unit 112, an angle θ2 (see FIG. 6A) in the extending direction of the second ribs 118 and the first ribs 115 intersecting relative to the outer side surface of the ink cartridge 100 is 30 degrees or more and 45 degrees or less. More desirably, the angle θ2 is 45 degrees.

FIGS. 6A to 6D illustrate states where the first rib 115 bends to provide an elastic effect in a case where the container 110 is dropped. If the container 110 storing the ink cartridge 100 is dropped on the ground, the shock makes the second part 1152 of the first rib 115 come into contact with the head unit 105, as illustrated in FIGS. 6A to 6D. Since a plurality of the first ribs 115 is provided, the drop shock is dispersed to multiple positions and received by multiple points, thus preventing the head unit 105 from being locally largely deformed. Since the first ribs 115 are inclined relative to the ink cartridge 100, the inner surface of the container 110 has flexibility against a force applied from the outside of the head unit 105, whereby the drop shock can be buffered by deformation. If a drop shock is received, the head unit 105 comes into contact with the second part 1152 of the first rib 115, as illustrated in FIG. 6B. If the head unit 105 further shifts its position relative to the storage unit 112 by the shock, the first rib 115 elastically bends, as illustrated in FIG. 6C. The elastic force of the first rib 115 increases with increase in the degree of bending of the first rib 115. Therefore, even if a shock is applied from the outside, the first rib 115 absorbs the shock and is able to reduce the shock applied to the head unit 105. Since the plurality of the first ribs 115 are disposed, the shock applied to each of the first ribs 115 is decreased, and the amount of deformation is decreased, whereby the drop shock is buffered, and at the same time, the ink cartridge 100 is prevented from receiving a shock due to direct contact with the storage unit 112 (inner wall of the container 110).

In addition, the second ribs 118 and the first parts 1151 of the first ribs 115 are disposed at positions not corresponding to the head fixing surface 1014 and the head fixing part side faces 1015. Thus, the drop shock is not directly applied to the head unit 105, whereby the head unit 105 is hardly damaged.

Referring to the cross-sectional view in FIG. 4C, the first ribs 115 are disposed to face a side surface of the ink cartridge 100 over almost the entire range of the discharge substrate 106 having the discharge ports. It is desirable that the first ribs 115 are disposed over at least two-thirds of the length of the discharge substrate 106 in the side surface direction of the ink cartridge 100. With this configuration, the drop shock is dispersed in the length direction of the discharge substrate 106 to prevent the shock from being locally applied to the head unit 105 and the discharge substrate 106, which prevents the head unit 105 and the discharge substrate 106 from being largely deformed and damaged.

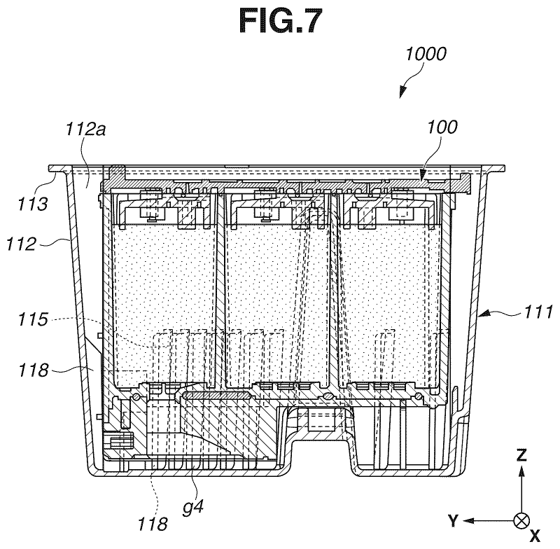

As illustrated in FIGS. 5A and 5B, the height of the second part 1152 of the first rib 115 is set so that a vertex 1152a of the second part 1152 of the first rib 115 supports the bottom 104a of the ink stores 104 from below when the ink cartridge 100 is stored in the storage unit 112. In other words, the vertex 1152a is configured to support the bottom 104a of the ink stores 104 from the side of the head unit 105. FIG. 7 is a cross-sectional view illustrating the container 110 and the ink cartridge 100 stored in the container 110, viewed in the side surface direction. When the ink cartridge 100 is stored in the storage unit 112, a gap g4 exists between the discharge substrate 106 and the bottom of the storage unit 112 (see FIGS. 5A, 5B, and 7). With this configuration, the discharge substrate 106 is prevented from coming into contact with the bottom of the storage unit 112.

If a shock exceeding a certain level is applied from the outside, in a case of dropping, for example, the second ribs 118 and the first ribs 115 disperse the shock to multiple positions on the side surface of the ink cartridge 100 to prevent the shock from being directly applied to the head unit 105. Particularly, the first parts 1151 of the first ribs 115 facing the side surface of the ink cartridge 100 regulate the position of the ink cartridge 100, and at the same time, the second parts 1152 of the first ribs 115 facing the head unit 105 buffer the shock to the head unit 105.

Even in a case of increase in the weight of the ink cartridge 100, the second ribs 118 and the first parts 1151 of the first ribs 115 disperse the shock to multiple positions on the side surface of the ink cartridge 100, whereby a strong shock is prevented from being directly applied to the head unit 105. Further, since the second parts 1152 of the first ribs 115 are disposed to the side of the head unit 105, if the container 110 drops, the first ribs 115 are bent to absorb the shock. This enables the ink cartridge 100 to be prevented from being damaged at a low cost without adding a new shock absorbing member.

Particularly, the first ribs 115 have a role of regulating the position of the container 110 and a role of absorbing the shock to the head unit 105. It is desirable that the container 110 be provided with a plurality of the first ribs 115 to effectively obtain the above-described function of the first rib 115.

Referring to the cross-sectional view in FIG. 4B, the lower side surface of the storage unit 112 is provided with only one first rib 115. This is to avoid causing the second part 1152 of the first rib 115 to interfere with the protection seal 109. If the protection seal 109 is not stuck on the ink cartridge 100, a plurality of the first ribs 115 may be disposed on the lower side surface, like the upper side surface in the cross-sectional view in FIG. 4B.

An embodiment has been described above centering on the ink cartridge 100 and the container 110. However, the configuration of the above-described embodiment is applicable to a liquid cartridge using a non-ink liquid instead of ink, and a container corresponding to the liquid cartridge.

The above-described embodiment is based on a configuration in which the head unit 105 is protected by the second ribs 118 and the first ribs 115. However, parts other than the head unit 105 of the ink cartridge 100 may be protected by the second ribs 118 and the first ribs 115. The present disclosure is also desirably applicable to a container for storing an ink cartridge not having the head unit 105.

After the cover 114 is detached from the main body 111, and the ink cartridge 100 is taken out, a new cover 114 may be prepared, which results in production of the liquid cartridge container 1000 in which the main body 111 is reused. In this case, the liquid cartridge container 1000 reusing the main body 111 can be produced by collecting the main body 111, storing a new ink cartridge 100 in the collected main body 111, and welding a new cover 114 to the main body 111. In the collecting, if the main body 111 is collected with the used ink cartridge 100 stored in the main body 111, the ink cartridge 100 can also be recycled or reused. Particularly, at the time of collection of the ink cartridge 100 with the discharge substrate 106, the use of the main body 111 of the container 110 according to the present disclosure makes it easier to reduce the damage to the head unit 105 and the discharge substrate 106.

According to the present disclosure, even if a container for a liquid cartridge receives a shock, the liquid cartridge stored in the container can be prevented from being damaged.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2024-104681, filed Jun. 28, 2024, which is hereby incorporated by reference herein in its entirety.

What is claimed is:

1. A container for storing a liquid cartridge that is attachable to a liquid discharge apparatus, the container comprising:
a storage unit including a bottom and at least four side walls; and
an opening facing the bottom,
wherein a plurality of ribs protrudes from an inner surface of at least one of the at least four side walls of the storage unit toward an inside of the storage unit and extends from the bottom toward the opening, and
wherein the plurality of ribs includes a plurality of first ribs which are configured to protrude in a direction parallel to the bottom and inclined relative to the at least one of the at least four side walls.

2. The container according to claim 1, wherein the plurality of first ribs is inclined relative to the at least one of the at least four side walls by an angle of at least 30 degrees and up to 45 degrees.

3. The container according to claim 1, wherein at least one of the plurality of first ribs includes a first part and a second part having a protrusion length longer than a protrusion length of the first part.

4. The container according to claim 3, wherein the second part of the at least one of the plurality of first ribs has a protrusion length of 2.0 mm or more.

5. The container according to claim 3, wherein the plurality of ribs includes a second rib which is configured to protrude and is inclined relative to the at least one of the at least four side walls, wherein the second rib is configured with a protrusion length shorter than a protrusion length of the second part.

6. The container according to claim 1, wherein the plurality of first ribs is disposed on two opposing side walls of the at least four side walls.

7. The container according to claim 1, wherein the plurality of first ribs is elastically deformable.

8. The container according to claim 1, wherein the container is made of plastic.

9. The container according to claim 8, wherein the container includes a recycled plastic material.

10. A liquid cartridge container comprising:
the liquid cartridge; and
the container according to claim 1, configured to store the liquid cartridge.

11. The liquid cartridge container according to claim 10,
wherein the liquid cartridge includes
a head unit connectable with a discharge substrate having discharge ports for discharging a liquid; and
a reservoir connected with the head unit and configured to store the liquid, and
wherein when the liquid cartridge is stored in the storage unit, the plurality of first ribs is disposed to face the head unit in a direction intersecting with the at least one of the at least four side walls.

12. The liquid cartridge container according to claim 10,
wherein at least one of the plurality of first ribs includes a first part and a second part having a protrusion length longer than a protrusion length of the first part, and
wherein, in a direction intersecting with the at least one of the at least four side walls, the first part of the at least one of the plurality of first ribs is arranged to face the head unit, and the second part of the at least one of the plurality of first ribs is arranged to face a side surface of the liquid cartridge corresponding to the reservoir.

13. The liquid cartridge container according to claim 12, wherein a distance between the first part and the head unit in a direction parallel to a protrusion direction of the plurality of first ribs is larger than a distance between the second part and the side surface.

14. The liquid cartridge container according to claim 12,
wherein, in a position of the liquid cartridge stored in the storage unit, a width of the reservoir is larger than a width of the head unit, and
wherein a vertex of the second part supports the reservoir from a side with the head unit when the liquid cartridge is stored in the storage unit.

15. The liquid cartridge container according to claim 11, wherein the plurality of first ribs are arranged in a position corresponding to a region ranging over at least two-thirds of a length of the discharge substrate in a side surface direction of the liquid cartridge.

16. The liquid cartridge container according to claim 10, wherein the liquid cartridge is configured to store ink.

17. The liquid cartridge container according to claim 10, wherein the liquid cartridge container is provided with a cover welded to the container.

18. A method for collecting a liquid cartridge that has been attached to and used in a liquid discharge apparatus, the method comprising:
collecting the liquid cartridge by storing the liquid cartridge in a container, the container including
a storage unit including a bottom and at least four side walls; and
an opening facing the bottom,
wherein a plurality of ribs is configured to protrude from an inner surface of at least one of the at least four side walls of the storage unit toward an inside of the storage unit and extends from the bottom toward the opening, and
wherein the plurality of ribs includes a plurality of first ribs which are configured to protrude in a direction parallel to the bottom and inclined relative to the at least one of the at least four side walls.

19. A container for storing a liquid discharge head that is attachable to a liquid discharge apparatus, the container comprising:
a storage unit including a bottom and at least four side walls; and
an opening facing the bottom,
wherein a plurality of ribs is configured to protrude from an inner surface of at least one of the four side walls of the storage unit toward an inside of the storage unit and extends from the bottom toward the opening, and
wherein the plurality of ribs includes a plurality of first ribs which are configured to protrude in a direction parallel to the bottom and inclined relative to the at least one of the at least four side walls.
